(19) United States
(12) Patent Application Publication
(10) Pub. No.: US 2020/0271431 A1
(43) Pub. Date: Aug. 27, 2020

(54) Angular measurement tool with safety guard

(71) Applicants: Joseph Dewey Nestasie, Bessemer, PA (US); James D. Nestasie, Edinburgh, PA (US)

(72) Inventors: Joseph Dewey Nestasie, Bessemer, PA (US); James D. Nestasie, Edinburgh, PA (US)

(73) Assignees: Joseph Dewey Nestasie, Bessemer, PA (US); James D. Nestasie, Edinburgh, PA (US)

(21) Appl. No.: 16/501,084

(22) Filed: Feb. 21, 2019

(51) Int. Cl. G01B 5/00; G01B 3/04; B43L 7/027

(52) U.S. Cl. CPC G01B 5/0009; B43L 7/0275; G01B 3/04

(57) ABSTRACT

A speed square consisting of a three sided isosceles triangle that is used in the construction industry as well as the do-it-yourselfer. Consisting of a lead side of a 90 degree angle, a hypotenuse side with a scale of angular degrees ranging from 5 degrees to 90 degrees. The third side and most important side has a scale of inches divided into increments of ⅛″, but furthermore and most importantly the third side has a raised edge of ¼″ that when utilized to be used as a safety guide in the act of cutting a straight line. This also acts as a barrier when using such instruments as a utility knife, thus reducing the risk of injury to the hand or fingerers.

The device that I am presenting is most helpful to the skilled craftsman as well as a novice do-it-yourselfer familiar with measuring material for a particular home project or within the construction industry.

The device is used for the determining a pitch of a roof or the determining of an angle. The device is a three sided instrument consisting of a right triangle on the lead side and a scale on the hypotenuse side used in determining angular measurement in degrees. The remaining side is used for an accurate cutting edge, however this side is the focal point of the uniqueness of this device. The number scaled side is in fact raised to the height of ¼″ to not only accommodate a reinforced guide for cutting, but more particularly serves as a safety guard when using cutting instruments such as a utility knife. Thus reducing the probability of an accidental wound caused by the cutting blade jumping over the cutting edge.

### SUMMARY OF THE INVENTION

The ANGULAR MEASURING TOOL is in fact an isosceles triangular device with a right angle as its base as well as a angle scale located on the hypotenuse side divided into angular degrees. The remaining third side has a scale that is divided into ⅛″ increments. This side is also raised ¼″ to be utilized as a cutting guide as well as a safety guard while cutting with a saw or utility knife.

### DESCRIPTION OF DRAWINGS

FIG. 1

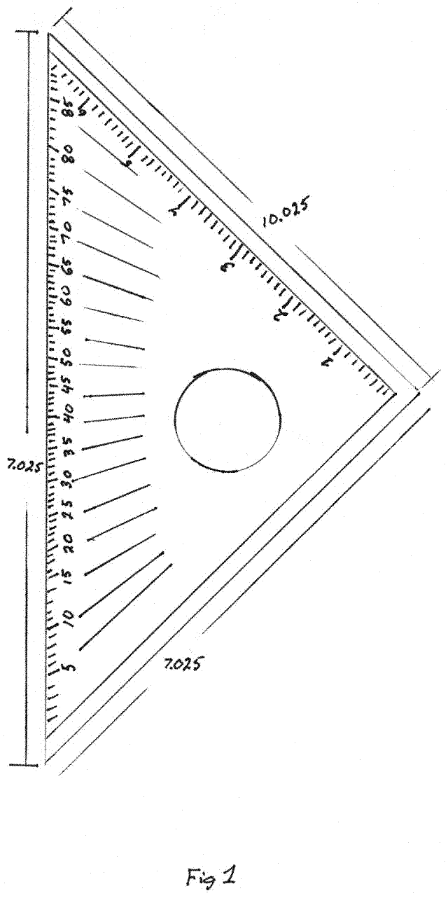

The drawing shows the right triangular side of the aforementioned measuring device along with the angular divisions marketed in 5 degree increments starting at zero and ending at 90 degrees. The third side illustrates the ¼″ raised cutting edge that acts as a safety device prohibiting the appliance whether a saw or a utility knife from riding over the raised edge therefore reducing the probability of an accident of injury.

FIG. 2

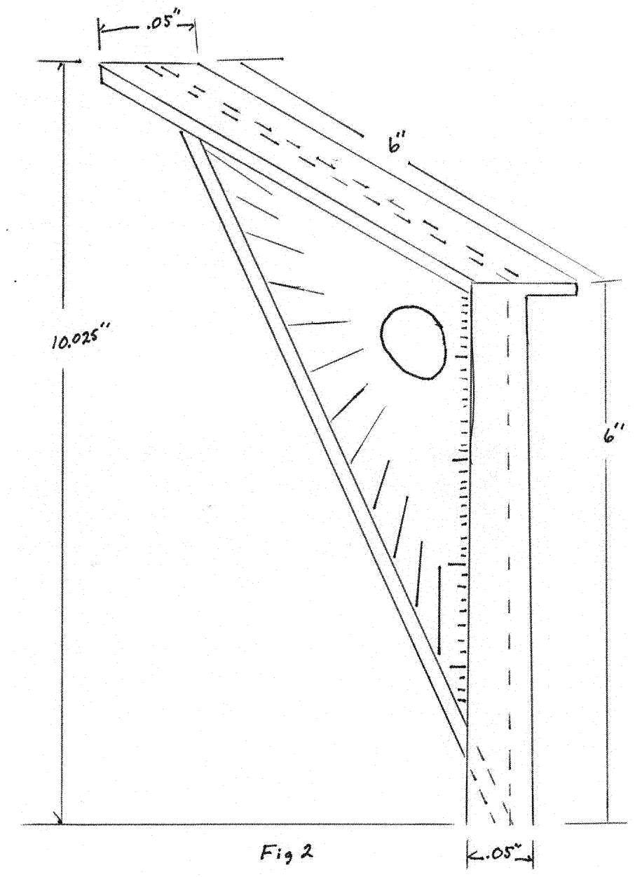

The drawing is an abstract drawing showing the lead side of an isosceles triangle which allows for the cutting or marking a perfect 90 degree angle. The hypotenuse side is used for the determining of angular measurements. The third and most important side provides a straight plain used for marking straight lines. Also this raised edge provides a barrier between a cutting device such as a saw or utility knife. Thus reducing the probability of injury to hands or fingers.

### DETAILED DESCRIPTION OF THE INVENTION

The ANGULAR MEASURING TOOL with SAFETY GUARD is a most useful tool for the skilled craftsman as well as the do-it-yourselfer. It consists of a 90 degree right angle on the lead side of an isosceles triangle. The larger or hypotenuse side is divided into 5 degree increments starting at 5 degrees through 90 degrees. The remaining side has a scale in inched divided into ⅛″ increments with a raised edge of ¼″ to be utilized as a stronger edge for the guidance a saw or the safety of a cutting edge when using cutting instruments such as a utility knife thus decreasing the probability of an accidental over riding of the cutting edge.

1. The invention claimed is a speed square in the form of an isosceles triangle. The three sides comprising of a 90 degree lead side a hypotenuse side and a third side completing the triangle.

2. The right angle side claimed in claim 1, is divided in increments of inches sub divided into ⅛″. The hypotenuse side of the triangle is divided into degrees, ranging from 5 degrees to a maximum of 90 degrees, used for the purpose of figuring angle measurements.

3. The remaining side as claimed in claim 1, is divided into inch increments and divided in ⅛″ increments. The unique aspect of this third side serves as a guide in the process of cutting a straight line along a level plain. Furthermore this third side having a raised edge of ¼″ is most useful when used in the cutting process along with the feature of helping to restrict the cutting edge of a utility knife, thus reducing the probability of injury to hands or fingers.
